(19) United States
(12) Patent Application Publication
(10) Pub. No.: US 2011/0147351 A1
(43) Pub. Date: Jun. 23, 2011

(54) LASER PROCESSING APPARATUS AND LASER PROCESSING METHOD

(75) Inventors: Takanori Miyazaki, Chiyoda-ku (JP); Takashi Inoue, Chiyoda-ku (JP); Hiroyuki Murai, Nagoya-shi (JP)

(73) Assignee: MITSUBISHI ELECTRIC CORPORATION, Chiyoda-ku, Tokyo (JP)

(21) Appl. No.: 12/996,345

(22) PCT Filed: Jun. 1, 2009
(86) PCT No.: PCT/JP2009/059996

§ 371 Date: Dec. 3, 2010

(30) Foreign Application Priority Data
Jun. 4, 2008 (JP) 2008-147174

(51) Int. Cl. B23K 26/38

(52) U.S. Cl. 219/121.71; 219/121.7

(57) ABSTRACT

A laser processing apparatus for piercing a workpiece and cutting the pierced workpiece by irradiating the workpiece with a laser beam. The apparatus includes: a laser beam projection unit for projecting the laser beam onto the workpiece with the focus position thereof set to lie within the workpiece and in the vicinity of the surface of the workpiece at least when piercing is started; and a laser oscillator that emits the laser beam as a pulsed laser having a frequency at which plasma is generated when the workpiece is irradiated with the laser beam at the focus position set through the laser beam projection unit when the piercing is started.

### TECHNICAL FIELD

The present invention relates to a laser processing apparatus for cutting a workpiece after piercing and to a laser processing method.

### BACKGROUND ART

A laser processing apparatus is an apparatus for cutting a desired work (product) or an unnecessary part from a workpiece such as a mild steel workpiece by irradiating the workpiece with a laser beam. In such a laser processing apparatus, piercing is performed at the beginning of the processing, and then the work is cut such that the cut work does not include the pierced hole which is formed at the beginning of the processing. Therefore, to cut a small unnecessary part from a workpiece, a small pierced hole must be formed. With conventional piercing techniques, the power of the laser beam must be reduced to reduce the diameter of a pierced hole, and the piercing therefore takes a long time. This is because, if the power of the laser beam is increased to reduce the piercing time, the diameter of the pierced hole increases. As described above, in the conventional piercing techniques, a reduction in the diameter of the pierced hole and a reduction in the piercing time cannot be achieved at the same time.

For example, in a laser processing apparatus described in Patent document 1, the focus position of a condenser lens is lowered in the depth direction of a workpiece during piercing to achieve high-speed and stable piercing.

### PRIOR ART DOCUMENT

### Patent Document

Patent document 1: Japanese Patent Application Laid-Open No. Hei 2-160190

### DISCLOSURE OF INVENTION

### Problem to be Solved by the Invention

However, in the above conventional technology, the increase in the piercing speed is insufficient. In addition, the focus position of the condenser lens must be moved to a suitable position according to the progress of piercing, and this causes the problem in that the control of the focus position is complicated.

The present invention has been made in view of the above circumstances, and it is an object of the invention to obtain a laser processing apparatus and a laser processing method in which piercing can be easily performed in a short period of time.

### Means for Solving Problem

In order to solve the above problem, and in order to attain the above object, in a laser processing apparatus for piercing a workpiece and cutting the pierced workpiece by irradiating the workpiece with a laser beam, the laser processing apparatus of the present invention includes a laser beam projection unit for projecting the laser beam onto the workpiece with a focus position of the laser beam set to lie within the workpiece and in the vicinity of a surface of the workpiece at least when piercing is started, and a laser oscillator that emits the laser beam as a pulsed laser having a frequency at which plasma is generated when the workpiece is irradiated with the laser beam at the focus position set through the laser beam projection unit when the piercing is started.

### Effect of the Invention

According to the present invention, the focus position of the laser beam is set to lie within the workpiece and in the vicinity of the surface thereof when piercing is started, and the laser beam is emitted as pulses at a frequency at which plasma is generated. Therefore, the invention has an effect that piercing can be easily performed in a short period of time.

### BRIEF DESCRIPTION OF DRAWINGS

FIG. 1 is a diagram for illustrating the concept of piercing according to a first embodiment.

FIG. 2 is a diagram illustrating the schematic structure of a laser processing apparatus according to the first embodiment.

FIG. 3-1 is a diagram illustrating the frequency of a laser beam used for conventional piercing.

FIG. 3-2 is a diagram illustrating the frequency of a pulsed laser beam used in the laser processing apparatus of the present embodiment during piercing.

FIG. 4-1 is a diagram illustrating the focus position of the laser beam used for the conventional piercing.

FIG. 4-2 is a diagram illustrating the focus position of the laser beam emitted from the laser processing apparatus of the present embodiment when piercing is started.

FIG. 5-1 is a diagram illustrating the relationship between a change in the curvature of a bend mirror and a change in the focus position when the bend mirror has a convex surface.

FIG. 5-2 is a diagram illustrating the relationship between a change in the curvature of the bend mirror and a change in the focus position when the bend mirror has a concave surface.

FIG. 6-1 is a diagram illustrating the laser beam diameter used when piercing is started.

FIG. 6-2 is a diagram illustrating the laser beam diameter used after a lapse of a predetermined time after the start of the piercing.

FIG. 7-1 is a diagram illustrating the relationship between a change in the curvature of the bend mirror and a change in the beam diameter when the bend mirror has a convex surface.

FIG. 7-2 is a diagram illustrating the relationship between a change in the curvature of the bend mirror and a change in the beam diameter when the bend mirror has a concave surface.

FIG. 8-1 is a diagram illustrating the laser beam with a large diameter used when the piercing is started.

FIG. 8-2 is a diagram illustrating the laser beam with a small diameter used after a lapse of a predetermined time after the start of the piercing.

FIG. 9 is a diagram illustrating the change in the beam diameter during piercing.

FIG. 10 is a diagram illustrating the structure of a processing head.

FIG. 11 is a series of diagrams for illustrating a method of detecting reflected light.

### BEST MODE(S) FOR CARRYING OUT THE INVENTION

A laser processing apparatus and a laser processing method according to embodiments of the present invention will next be described in detail with reference to the drawings. However, the present invention is not limited to the embodiments. Piercing in the following description is a process for forming a pierced hole in a workpiece, and cutting is a process for cutting a work or an unnecessary part from the workpiece.

### First Embodiment

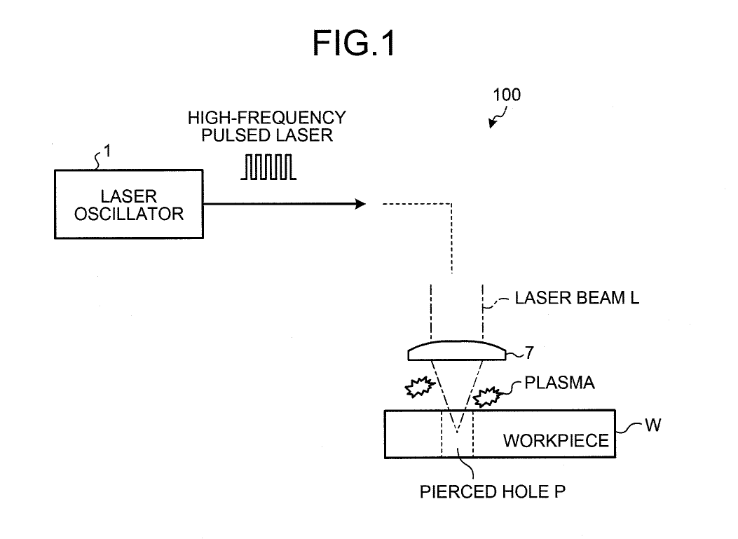

First, the concept of piercing in the present embodiment will be described. FIG. 1 is a diagram for illustrating the concept of piercing according to the first embodiment. A laser processing apparatus 100 includes: a laser oscillator 1 for oscillating a laser beam L as a pulsed laser beam; and a processing lens 7 for condensing the laser beam L on a small diameter spot to irradiate a workpiece W (such as a mild steel workpiece) with the laser beam L. The processing lens 7 is adjusted in a height direction (in a projection direction of the laser beam L) so as to control the focus position of the laser beam L directed to the workpiece W.

At least when the piercing is started, the processing lens 7 in the present embodiment sets the focus position so that the focus position lies within the workpiece W and in the vicinity of the surface thereof (below the surface). The laser oscillator 1 oscillates the laser beam L at a high frequency at which plasma can be generated in the processing position of the workpiece W when the laser beam is projected at the set focus position. The high frequency used herein is a frequency that is higher than the frequency used in, for example, conventional piercing (a frequency at which plasma is not generated) and is lower than the frequency used for cutting. In this manner, the laser processing apparatus 100 performs piercing of the workpiece W while plasma is generated, so that a pierced hole P is formed in the workpiece W.

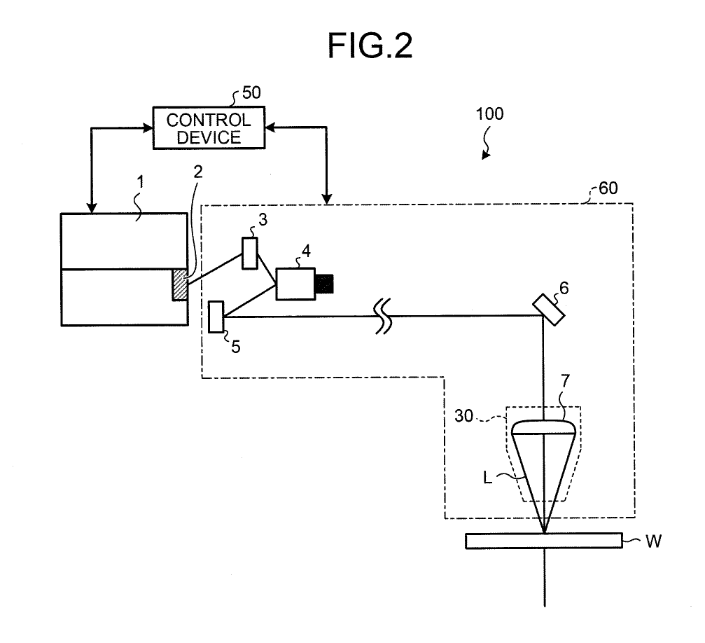

FIG. 2 is a diagram illustrating the schematic structure of the laser processing apparatus according to the first embodiment of the present invention. The laser processing apparatus 100 includes the laser oscillator 1, a PR (Partial Reflection) mirror 2, a laser beam projection unit 60, and a control unit 50.

The laser oscillator 1 is a device, such as a CO2 laser, for oscillating the laser beam L and emits the laser beam during laser processing such as piercing or cutting while the oscillation frequency or the laser power is variously changed. The laser oscillator 1 in the present embodiment changes the frequency of the output laser beam L according to the type of processing such as piercing or cutting. The laser beam projection unit 60 includes a bend mirror 3, a beam optimization unit 4, bend mirrors 5 and 6, and a processing head 30.

The PR mirror (Partial Reflection mirror) 2 reflects part of the laser beam emitted from the laser oscillator 1 and guides the reflected beam to the bend mirror 3. The bend mirror (mirror for changing the angle of the beam) 3 changes the angle of the laser beam from the PR mirror 2 and guides the laser beam to the beam optimization unit 4.

The beam optimization unit (unit for changing the beam diameter) 4 adjusts the diameter of the laser beam from the bend mirror 3 and redirects the resultant beam to the bend mirror 5. The bend mirrors 5 and 6 are mirrors for changing the angle of the laser beam. The bend mirror 5 changes the angle of the laser beam from the beam optimization unit 4 such that the beam direction is changed to a horizontal direction to redirect the resultant beam to the bend mirror 6. The bend mirror 6 changes the angle of the laser beam from the bend mirror 5 such that the beam direction is changed to a vertically downward direction to redirect the resultant beam to the processing head 30. A mirror (not shown) for changing polarization is disposed between the bend mirror 5 and the bend mirror 6.

The processing head 30 has the processing lens 7. The processing lens 7 condenses the laser beam from the bend mirror 6 on a small diameter spot to irradiate the workpiece W with the laser beam. In the processing lens 7 in the present embodiment, the focus position thereof is adjusted according to the type of processing such as piercing or cutting. The processing lens 7 is configured such that the focus position is located, for example, below the surface of the workpiece W during piercing and above the surface of the workpiece W during cutting. The workpiece W is placed on a processing table (not shown) and subjected to laser processing on the processing table.

The control unit 50 is connected to the laser oscillator 1 and to the laser beam projection unit 60 to control the laser oscillator 1 and the laser beam projection unit 60. The laser processing apparatus 100 performs laser processing of a workpiece W such as mild steel by, for example, oxygen cutting using oxygen as an assist gas. In this case, the laser processing apparatus 100 sets the focus position with respect to the mild steel so that the focus position lies in the vicinity of and below the material surface during the laser processing. In addition to this, the laser processing apparatus 100 sets the frequency of the laser beam to be greater than a predetermined value to generate plasma. In this manner, the laser processing apparatus 100 performs piercing of the mild steel in the generated plasma.

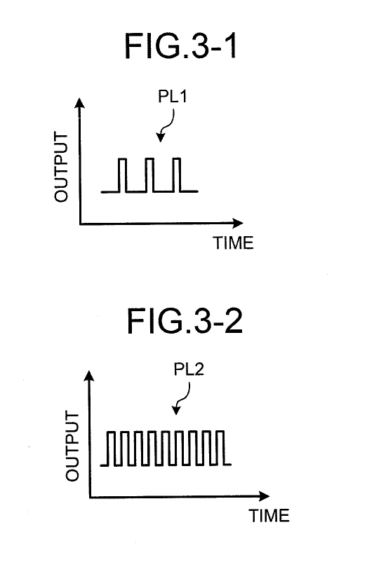

FIGS. 3-1 and 3-2 are diagrams for illustrating the frequencies of pulsed laser outputted from laser oscillators during piercing. The graph shown in FIG. 3-1 illustrates the frequency of the laser beam (pulsed laser) used for conventional piercing. The graph shown in FIG. 3-2 illustrates the frequency of the pulsed laser used for piercing in the laser processing apparatus 100 of the present embodiment.

The pulsed laser used for conventional piercing (the laser beam having a frequency at which plasma is not generated) is referred to as a pulsed laser PL1. The pulsed laser PL2 used for piercing in the present embodiment is a laser beam having a frequency higher than that of the pulsed laser PL1.

The pulsed laser PL2 can have any frequency so long as plasma is generated when a workpiece W is irradiated with the laser beam with its focus position set using the processing lens 7 (so as to lie below the surface of the workpiece W).

The laser processing apparatus 100 may utilize a pulsed laser having a frequency lower than that of the pulsed laser PL2 at the beginning of the piercing to prevent the occurrence of burning. In such a case, after the piercing is started, a frequency that causes no burning is used for a predetermined time to progress the piercing. Then the laser beam is changed to the pulsed laser PL2, and the piercing is continued. When the frequency used to prevent the occurrence of burning is changed to the frequency of the pulsed laser PL2, the frequency is gradually increased after a lapse of the predetermined time after the start of the piercing.

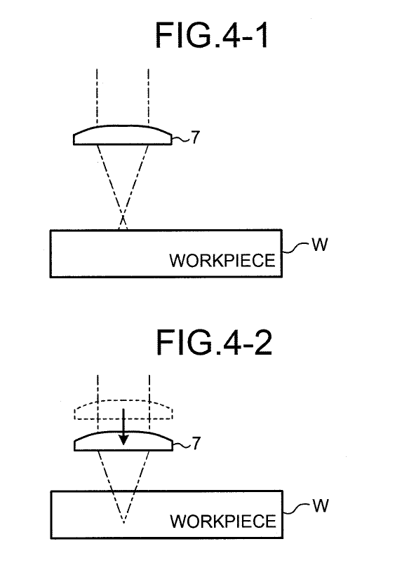

FIGS. 4-1 and 4-2 are diagrams for illustrating the focus positions of laser beams projected onto workpieces during piercing. FIG. 4-1 is a diagram illustrating the focus position of the laser beam used for conventional piercing. In the conventional piercing, the focus position of the laser beam lies above the surface of the workpiece W. In FIG. 4-2, the focus position of the laser beam lies below the surface of the workpiece W. In the laser processing apparatus 100 of the present embodiment, the focus position of the laser beam is set to lie in the vicinity of the surface of the workpiece W when piercing is started, as shown in FIG. 4-2. Desirably, the focus position of the laser beam is set to lie below the surface of the workpiece W.

In the laser processing apparatus 100, the focus position of the laser beam may be moved downward as the piercing proceeds. In other words, the laser processing apparatus 100 may perform piercing while the focus position of the processing lens 7 is moved downward in the direction of the processing depth of the workpiece W during the piercing. In the laser processing apparatus 100, the focus position of the laser beam may be fixed at the initially set focus position during piercing.

In the laser processing apparatus 100, cutting is performed after completion of the piercing. In the laser processing apparatus 100, the focus position of the laser beam is set to lie above the surface of the workpiece W when the workpiece W is cut.

The focus position of the laser beam L projected onto the workpiece W may be controlled using the bend mirror 6. In such a case, the bend mirror 6 is formed as a mirror having a variable curvature (a variable curvature mirror). An exemplary structure of the variable curvature bend mirror 6 is next described. Such a variable curvature bend mirror 6 includes a laser beam reflecting member that can change its curvature through the pressure of fluid such as air or water, a reflecting member-supporting member, fluid supplying means, means for changing the pressure for supplying the fluid stepwise or continuously, and fluid discharging means.

The laser beam reflecting member is disposed in the optical path of the laser beam and elastically deformed by the pressure of the fluid. The reflecting member-supporting member supports the circumferential portion of the laser beam reflecting member and forms, together with the laser beam reflecting member, a space on the side opposite to a laser beam reflecting surface. The fluid supplying means supplies the fluid to the space formed by the reflecting member-supporting member, and the fluid discharging means discharges the fluid from the space formed by the reflecting member-supporting member.

In the bend mirror 6, the space formed by the laser beam reflecting member and the reflecting member-supporting member has a closed structure except for a fluid supply path and a fluid discharge path. The fluid pressure required to elastically deform the laser beam reflecting member is applied to the side opposite to the laser beam reflecting surface. The laser beam reflecting member of the bend mirror 6 is deformed to have a concave or convex surface due to the change in the fluid pressure, so that the curvature of the surface is changed.

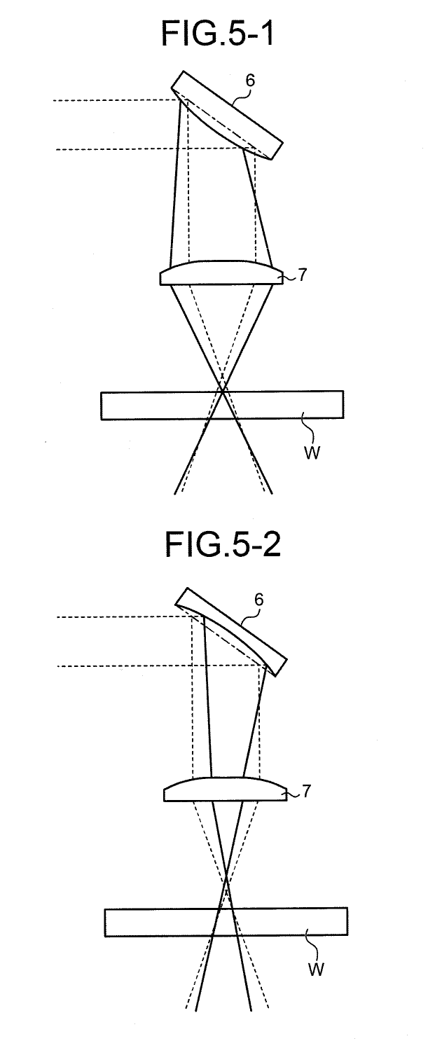

A description will now be given of the relationship between the change in the curvature of the bend mirror 6 and the change in the focus position. FIGS. 5-1 and 5-2 are diagrams for illustrating the relationships between the change in the curvature of the bend mirror and the change in the focus position. FIG. 5-1 illustrates the case where the bend mirror 6 has a convex surface, and FIG. 5-2 illustrates the case where the bend mirror 6 has a concave surface.

The focus position of the laser beam directed to the workpiece W through the bend mirror 6 having a convex surface is longer than that when a collimated laser beam L is directed to the workpiece W. The focus position of the laser beam L projected to the workpiece W through the bend mirror 6 having a concave surface is shorter than that when a collimated laser beam L is directed to the workpiece W.

As described above, by changing the curvature of the bend mirror 6, the focus position of the laser beam L projected onto the workpiece W can be changed, as in the case in which the position of the processing lens 7 is changed.

As described above, in the laser processing apparatus 100, the focus position is controlled, and the frequency of the pulsed laser is controlled to induce plasma during piercing. Therefore, the piercing is performed in the generated plasma. By generating the plasma during the piercing, the processing time for piercing can be reduced to about one-half of the processing time for conventional piercing. In addition, since the output laser beam is not required to have a high power, a small pierced hole can be formed in the workpiece W. Therefore, high speed processing of a pierced hole and a reduction in the diameter of the pierced hole can be achieved at the same time.

Accordingly, the time required to process the workpiece W can be reduced, and the running costs of the laser processing apparatus 100 can thereby be reduced. The reduction in the piercing time can suppress the heat input to the workpiece W (base material) to a low level. Therefore, the occurrence of processing failure (burning) caused by an increase in temperature of the base material can be suppressed. In the present embodiment, the control unit 50 and the laser beam projection unit 60 are separately provided. However, the laser beam projection unit 60 may include the control unit 50.

As described above, in the first embodiment, the focus position and frequency of the laser beam L projected onto the workpiece W are controlled to generate plasma during piercing. In this manner, the piercing can be performed in a short period of time.

### Second Embodiment

Next, a second embodiment of the present invention will be described with reference to FIGS. 6-1 to 9. In the second embodiment, in addition to the control of the focus position and frequency of the laser beam L, the diameter (flux diameter) of the laser beam L is controlled.

The laser processing apparatus 100 in the present embodiment changes the beam diameter during piercing to improve the efficiency of energy used for the laser processing of a pierced hole P. More specifically, in the laser processing apparatus 100, to avoid processing failure such as burning, the diameter of the beam incident on the processing lens 7 is set to a large value (a first beam diameter) at the beginning of the piercing. The diameter of the incident beam is changed to a smaller value (a second beam diameter) as the piercing proceeds.

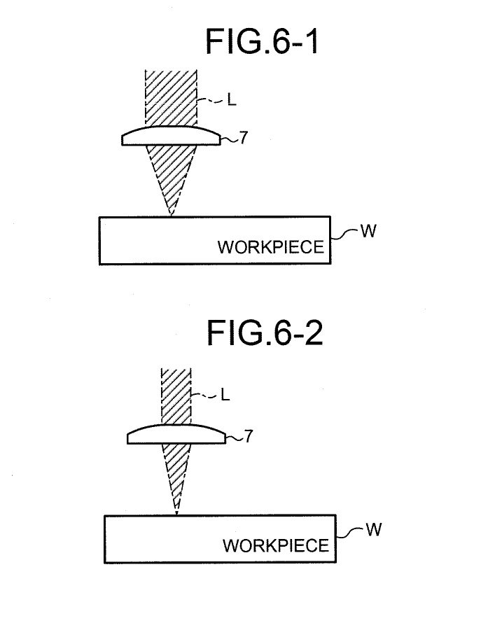

FIGS. 6-1 and 6-2 are diagrams for illustrating the diameters of a laser beam projected onto a workpiece during piercing. FIG. 6-1 is a diagram illustrating the diameter of the laser beam L that is used when the piercing is started. FIG. 6-2 is a diagram illustrating the diameter of the laser beam L that is used after a lapse of a predetermined time after the start of the piercing. In the laser processing apparatus 100 in the present embodiment, the diameter of the laser beam used for piercing is set to a large value when the piercing is started, and the beam diameter is then reduced during the piercing.

The diameter of the laser beam L projected onto the workpiece W may be controlled using, for example, a variable curvature bend mirror 6. The structure of such a variable curvature bend mirror 6 is the same as the bend mirror 6 in the first embodiment, and the description thereof is omitted.

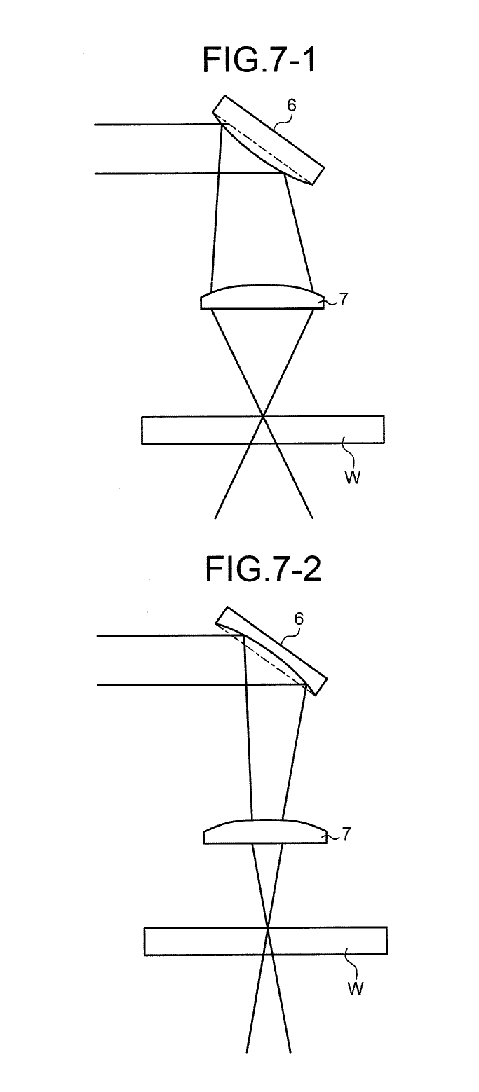

A description will now be given of the relationship between the change in the curvature of the bend mirror 6 and the change in the beam diameter. FIGS. 7-1 and 7-2 are diagrams for illustrating the relationships between the change in the curvature of the bend mirror and the change in the beam diameter. FIG. 7-1 shows the case where the bend mirror 6 has a convex surface, and FIG. 7-2 shows the case where the bend mirror 6 has a concave surface.

The laser beam L projected onto the workpiece W through the bend mirror 6 having a convex surface has a larger beam diameter than that when a collimated laser beam L is projected onto the workpiece W. The laser beam projected onto the workpiece W through the bend mirror 6 having a concave surface has a smaller beam diameter than that when a collimated laser beam L is projected onto the workpiece W.

As described above, by changing the curvature of the bend mirror 6, the diameter of the laser beam L projected onto the workpiece W can be changed. When the curvature of the bend mirror 6 is changed, the focus position of the laser beam L projected onto the workpiece W is displaced. Therefore, the displacement of the focus position is cancelled by, for example, changing the position of the processing lens 7. The displacement in the focus position may be cancelled by changing the position of the bend mirror 6. For example, when the surface of the bend mirror 6 is changed to a concave surface to reduce the diameter of the laser beam L, the focus position is moved upward. Therefore, when the diameter of the laser beam L is reduced, the change in the focus position is cancelled by lowering the processing lens 7 or the bend mirror 6.

The ratio of the laser beam that reaches the bottom surface of a pierced hole P is increased by reducing the diameter of the laser beam L. FIGS. 8-1 and 8-2 are diagrams for illustrating the relationships between the beam diameter and the amount of the laser beam that reaches the bottom surface of a pierced hole.

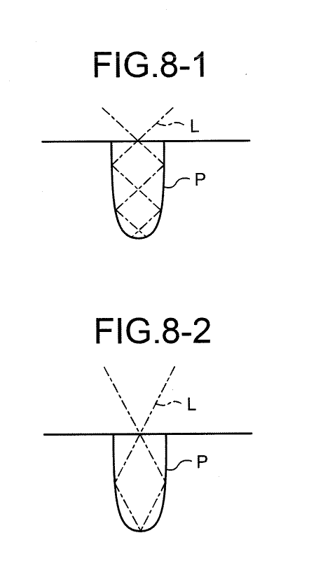

FIG. 8-1 shows the laser beam having a large diameter used when the piercing is started, and FIG. 8-2 shows the laser beam having a small diameter used after a lapse of a predetermined time after the start of the piercing.

As shown in FIG. 8-1, when the diameter of the beam that enters the pierced hole P is large, the amount of the laser beam L projected onto the side wall of the pierced hole P is large, and therefore the amount of the laser beam L that reaches the bottom surface of the pierced hole P is small. Therefore, the efficiency of energy used for forming the pierced hole P (piercing in the direction toward the bottom surface) is low.

In contrast, when the diameter of the beam that enters the pierced hole P is small as shown in FIG. 8-2, the amount of the laser beam L projected onto the side wall of the pierced hole P is smaller than that when the beam diameter is large, and the amount of the laser beam L that reaches the bottom surface of the pierced hole P is large. Therefore, the efficiency of energy used for forming the pierced hole P (piercing in the direction toward the bottom surface) is high.

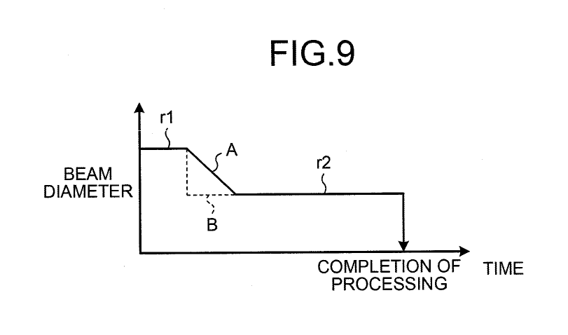

Next, a description will be given of the timing of changing the beam diameter during piercing. FIG. 9 is a diagram illustrating the change in the beam diameter during piercing. In the laser processing apparatus 100, the laser beam L with a large diameter r1 is projected onto the workpiece W when the piercing is started. In the laser processing apparatus 100, after the workpiece W is irradiated with the laser beam L for a predetermined time with the beam diameter set to the large diameter r1, the workpiece W is irradiated with the laser beam L with the beam diameter set to a value (beam diameter r2) smaller than the beam diameter r1. The beam diameter r1 may be changed to the beam diameter r2 by (A) gradually reducing the beam diameter or (B) switching from the beam diameter r1 to the beam diameter r2 at predetermined timing. Then in the laser processing apparatus 100, the laser beam L with the small diameter r2 is projected onto the workpiece W until the piercing is completed.

The timing of changing the beam diameter r1 to the beam diameter r2 corresponds to, for example, the timing at which no burning occurs even when the laser beam L with the beam diameter r2 is used for the laser processing of the workpiece W. In other words, in the laser processing apparatus 100, after the piercing is started, the laser beam L with the beam diameter r1 is used for the piercing until burning is prevented from occurring. Then the laser beam L with the beam diameter r2 is used for the piercing.

As described above, since the laser processing is performed with the beam diameter set to a large value when the piercing is started, burning at the beginning of the piercing can be suppressed. In addition, since the laser processing is performed with the beam diameter set to a small value after a predetermined time elapses and burning is prevented from occurring, energy can be efficiently transmitted to the deepest portion of the pierced hole P, and the piercing can thereby be performed in a short period of time.

As described above, in the second embodiment, in addition to the control of the focus position and frequency of the pulsed laser, the diameter of the laser beam L is controlled. Therefore, piercing can be performed in a shorter period of time than that in the laser processing apparatus 100 of the first embodiment.

### Third Embodiment

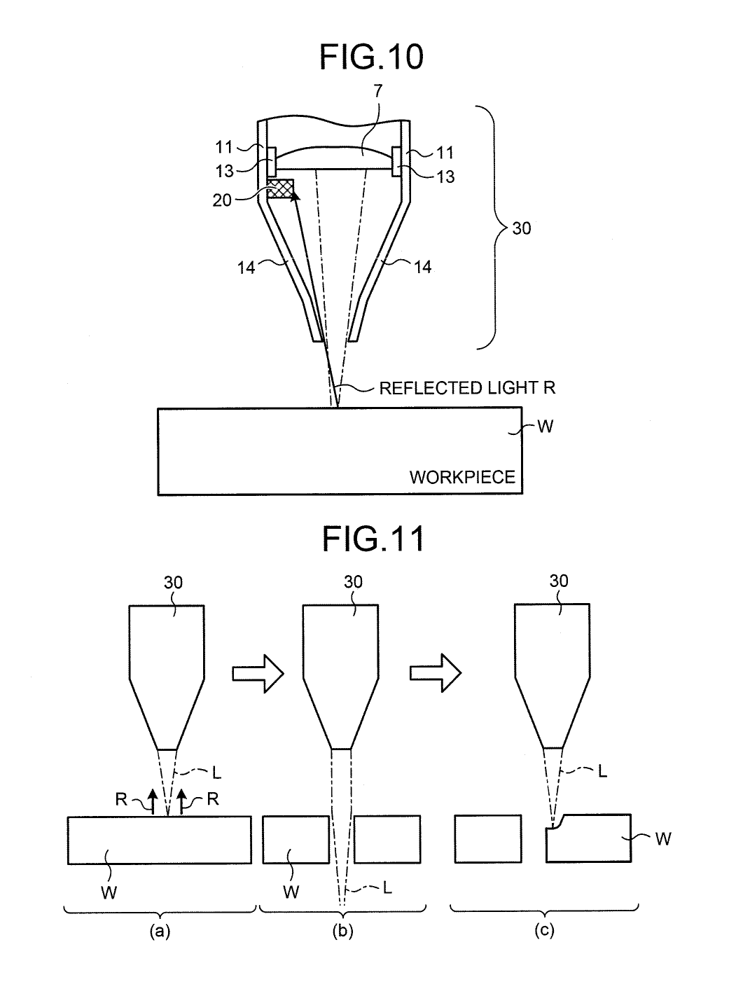

Next, a third embodiment of the invention will be described with reference to FIGS. 10 and 11. In the third embodiment, detection is made to determine whether or not the pierced hole P penetrates through during piercing, and the piercing is switched to cutting according to the detection results.

The laser processing apparatus 100 in the present embodiment starts piercing in the same manner as in the first and second embodiments. In the laser processing apparatus 100, light generated on the workpiece W side during piercing is detected by, for example, a sensor (a reflected-light detection sensor 20 described later) disposed in a processing head. A determination as to whether or not the pierced hole P penetrates through is made on the basis of the amount of the detected light (the amount of energy).

FIG. 10 is a diagram illustrating the structure of the processing head. The processing head 30 includes a lens supporting cylinder 11, a processing lens 7, a lens supporting spacer 13, a processing nozzle 14, and the reflected-light detection sensor (light amount detection sensor) 20.

The lens supporting cylinder 11 is a tubular body for accommodating the processing lens 7 and the lens supporting spacer 13 and is attached to the body of the laser processing apparatus 100 such that the optical axis coincides with the cylinder axis.

The processing lens 7 has a substantially disk shape and is disposed in the lens supporting cylinder 11 such that the principal plane of the lens is perpendicular to the direction of the optical axis (the direction of the depth of focus). The processing lens 7 is attached so as to be movable in the lens supporting cylinder 11 in the direction of the cylinder axis.

The lens supporting spacer 13 is disposed between the lens supporting cylinder 11 and the processing lens 7 and secures the processing lens 7 to a predetermined position in the lens supporting cylinder 11. The lens supporting spacer 13 is disposed so as to surround the side surface of the processing lens 7. The processing nozzle 14 is disposed on the lower side of the lens supporting cylinder 11, and the laser beam delivered through the processing lens 7 is projected onto the workpiece W side through the processing nozzle 14.

The reflected-light detection sensor 20 is a sensor for detecting the energy amount of light used to determine whether or not the pierced hole P penetrates through and is disposed inside the lens supporting cylinder 11. The reflected-light detection sensor 20 detects the energy amount of plasma light and light reflected from the workpiece W during piercing. The reflected-light detection sensor 20 sends the detected energy amount, which corresponds to the amount of reflected light R (light caused by irradiation with the laser beam L), to the control unit 50 of the laser processing apparatus 100. The control unit 50 controls the laser processing apparatus 100 according to the energy amount.

The control unit 50 starts piercing, and changes the piercing to cutting when, for example, the energy amount of the reflected light R is equal to or less than a predetermined value. The control unit 50 may change the piercing to cutting when the reduction amount of energy is equal to or greater than a predetermined value or when the reduction rate of energy is equal to or greater than a predetermined value.

Next, a description will be given of a method of detecting the reflected light R. FIG. 11 is a diagram for illustrating the method of detecting the reflected light R (the procedure of the processing). When the piercing is started in the laser processing apparatus 100, reflected light R is generated on the workpiece W side (a). The reflected light R includes reflected light generated by the reflection of the laser beam L from the workpiece W and plasma light generated by the irradiation of the workpiece W with the laser beam L. The reflected light R is detected by the reflected-light detection sensor 20 in the processing head 30. The energy amount (the light amount) of the reflected light R detected by the reflected-light detection sensor 20 depends on the energy amount of the laser beam L projected onto the workpiece W (the side wall and bottom surface of the pierced hole P during piercing) from the processing head 30, the shape of the pierced hole P during piercing, and other factors.

As the piercing proceeds, the pierced hole P penetrates through the bottom surface of the workpiece W (b), and the laser beam L passes through the bottom surface of the workpiece W toward the outside of the workpiece W. Therefore, the energy amount of the laser beam L projected onto the side surface of the pierced hole P is reduced. Since the bottom surface of the pierced hole P is not present, the laser beam L is no longer projected onto the bottom surface. Therefore, the amount of light reflected from the workpiece W is reduced. In addition, the amount of plasma generated between the workpiece W and the processing head 30 is reduced. The energy amount of the reflected light R is thereby reduced, and the energy amount detected by the reflected-light detection sensor 20 is also reduced. When the reflected-light detection sensor 20 detects a reduction in the energy amount, a determination is made by the laser processing apparatus 100 that the piercing is completed, and cutting of the workpiece W is started (c).

In conventional piercing, the processing time varies depending on the errors of the thickness and surface conditions of the workpiece W. Therefore, in some cases, the piercing is changed to cutting before the pierced hole penetrates through, and this may result in burning. To prevent the occurrence of burning, the set piercing time which is set as the processing time of piercing must allow for a margin. However, with this method, piercing may be continued even after the pierced hole penetrates through, and this causes a waste of piercing time.

In the present embodiment, the reflected light R is detected to determine whether or not the pierced hole P penetrates through. The piercing is changed to cutting after the pierced hole P penetrates through. In this manner, in the laser processing apparatus 100, piercing can be switched to cutting at appropriate timing regardless of the errors of the thickness and surface conditions of the workpiece W. Since piercing is switched to cutting after the pierced hole P actually penetrates through, cutting is not performed before the pierced hole P penetrates through. Therefore, the occurrence of processing failure can be prevented.

In the present embodiment described above, the reflected-light detection sensor 20 is disposed inside the lens supporting cylinder 11. However, the reflected-light detection sensor 20 may be disposed inside the processing nozzle 14. Moreover, the reflected-light detection sensor 20 may be disposed on the outer side of the processing head 30.

As described above, in the third embodiment, the timing of completion of the processing of the pierced hole P is detected using the reflected light R, and piercing is switched to cutting on the basis of the detection results. Therefore, the laser processing can be efficiently performed while the occurrence of processing failure is suppressed.

### INDUSTRIAL APPLICABILITY

As described above, the laser processing apparatus and the laser processing method according to the present invention are suitable for piercing of a workpiece using a laser beam.

### EXPLANATIONS OF LETTERS OR NUMERALS

1 laser oscillator
6 bend mirror
7 processing lens
9 workpiece
20 reflected-light detection sensor
30 processing head
50 control unit
60 laser beam projection unit
100 laser processing apparatus
L laser beam
P pierced hole
R reflected light
W workpiece

1.-4. (canceled)

5. A laser processing apparatus for piercing a workpiece and cutting the pierced workpiece by irradiating the workpiece with a laser beam, the apparatus comprising:
a laser beam projection unit for projecting the laser beam onto the workpiece with a focus position of the laser beam set to lie within the workpiece and in the vicinity of a surface of the workpiece at least when piercing is started; and
a laser oscillator that emits the laser beam as a pulsed laser having a frequency of a pulse at which plasma is generated when the workpiece is irradiated with the laser beam at the focus position set through the laser beam projection unit when the piercing is started.

6. The laser processing apparatus according to claim 5, wherein the laser beam projection unit irradiates the workpiece with the laser beam with a beam diameter thereof set to a first beam diameter when the piercing is started and then irradiates the workpiece with the laser beam with the beam diameter thereof set to a second beam diameter smaller than the first beam diameter to thereby proceed the piercing.

7. The laser processing apparatus according to claim 5, further comprising a light amount detection sensor for detecting an amount of light emitted on a workpiece side during the piercing, and wherein,
when a determination is made, based on the amount of light detected by the light amount detection sensor, that the piercing is completed, the laser beam projection unit changes the piercing to cutting.

8. The laser processing apparatus according to claim 6, further comprising a light amount detection sensor for detecting an amount of light emitted on a workpiece side during the piercing, and wherein,
when a determination is made, based on the amount of light detected by the light amount detection sensor, that the piercing is completed, the laser beam projection unit changes the piercing to cutting.

9. A laser processing method for piercing and then cutting a workpiece by irradiating the workpiece with a laser beam, the method comprising:
a focus position setting step of, at least when the piercing is started, setting a focus position so that the focus position lies within the workpiece and in the vicinity of a surface of the workpiece;
a laser oscillation step of emitting the laser beam as a pulsed laser having a frequency of a pulse at which plasma is generated when the workpiece is irradiated with the laser beam at the focus position set when the piercing is started; and
a laser beam irradiation step of irradiating the workpiece with the pulsed laser beam.
